(19) United States
(12) Patent Application Publication
(10) Pub. No.: US 2020/0319302 A1
(43) Pub. Date: Oct. 8, 2020

(54) Radar-Based Multi-Dimensional Motion Measurement For Gesture Recognition

(71) Applicant: Board of Trustees of Michigan State University, East Lansing, MI (US)

(72) Inventor: Jeffrey NANZER, Okemos, MI (US)

(73) Assignee: Board of Trustees of Michigan State University, East Lansing, MI (US)

(21) Appl. No.: 16/838,534

(22) Filed: Apr. 2, 2020

Related U.S. Application Data
(60) Provisional application No. 62/829,293, filed on Apr. 4, 2019.

(51) Int. Cl. G01S 7/41; G01S 7/35; G06F 3/01

(52) U.S. Cl. CPC G01S 7/415; G06F 3/017; G01S 7/354

(57) ABSTRACT

A gesture recognition system includes a transmitting antenna configured to transmit a signal generated by a transmitter onto an object. The system includes a receiving antenna device configured to receive a reflected signal. The reflected signal is a reflection of the transmitted signal, reflected off the object. The system includes a receiver configured to process the reflected signal.

### CROSS REFERENCE

This application claims the benefit of U.S. Provisional Application 62/829,293, filed Apr. 4, 2019. The entire disclosure of the above application is incorporated herein by reference.

### FIELD

The present disclosure relates gesture recognition and more particularly to radar-based off-broadside gesture recognition.

### BACKGROUND

There has been significant interest in recent years in developing wireless technologies for human-computer interaction (HCI). Of the various forms of HCI, gesture recognition is one of the most versatile methods due to the tactile ability of the human hand to generate a large and distinct number of gestures, representing a large dictionary of commands.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In accordance with the present invention, a gesture recognition system includes a transmitting antenna configured to transmit a signal generated by a transmitter onto an object. In further aspects, the system includes a receiving antenna device configured to receive a reflected signal. The reflected signal is a reflection of the transmitted signal reflected off the object. The system includes a receiver configured to process the reflected signal. The system includes a gestures database configured to store a set of known gestures represented by a corresponding frequency. The system includes an analyzing device configured to compute a shift in frequency over a predetermined period based on the processed reflected signal and obtain the set of known gestures stored in the gestures database. The analyzing device selects a first gesture included in the set of known gestures based on a corresponding first frequency matching the computed shift in frequency and outputs the selected first gesture to a display.

In further aspects, computing the shift in frequency over the predetermined period based on the processed reflected signal includes computing a first frequency based on a first velocity of a first reflected signal and computing a second frequency based on a second velocity of a second reflected signal. In further aspects, the shift in frequency is a difference between the first frequency and the second frequency. In further aspects, outputting the selected first gesture to the display includes outputting a selected graphic of the selected first gesture. In further aspects, the receiver configured to process the signal is further configured to measure an angular velocity of the object based on the reflected signal.

In further aspects, the receiver is an interferometric receiver. In further aspects, the receiving antenna device includes a first receiving antenna and a second receiving antenna spaced a preset distance apart. In further aspects, the first receiving antenna receives a first reflected signal, the second receiving antenna receives a second reflected signal, and computing the shift in frequency over the predetermined period based on the processed reflected signal includes calculating an angular velocity of the object based on the first reflected signal and the second reflected signal. In further aspects, the receiver includes a mixer and a low pass filter. In further aspects, the display is configured to display on a screen a graphical depiction of the shift in frequency.

A gesture recognition method includes transmitting a signal generated by a transmitter onto an object and receiving, by a receiver, a reflected signal. The reflected signal is a reflection of the transmitted signal reflected off the object. The method includes monitoring the reflected signal for a predetermined time and calculating a first velocity at a first time of the reflected signal and a second velocity at a second time. A difference between the first time and the second time is the predetermined time. The method includes determining a frequency shift over the predetermined time based on the first velocity and the second velocity and obtaining a set of known gestures. The set of known gestures is stored in a gestures database and each gesture of the set of known gestures corresponds to a predetermined frequency. The method includes comparing the frequency shift to the set of known gestures, selecting a first gesture of the set of known gestures based on a first predetermined frequency of the first gesture matching the frequency shift, and outputting the first gesture to a display screen.

In further aspects, the method includes computing a first frequency based on the first velocity at the first time and computing a second frequency based on the second velocity at the second time. The frequency shift is the difference between the first frequency and the second frequency. In further aspects, the method includes outputting a graphic of the selected first gesture.

In further aspects, the receiver measures an angular velocity of the object based on the reflected signal. In further aspects, the receiver is an interferometric receiver. In further aspects, the receiver receives the reflected signal from a first receiving antenna and a second receiving antenna spaced apart. In further aspects, the first velocity and the second velocity are angular velocities.

A gesture recognition system includes a transmitting antenna configured to transmit a signal generated by a transmitter onto an object and a receiving antenna device configured to receive a reflected signal. The reflected signal is a reflection of the transmitted signal reflected off the object. The system includes a receiver configured to process the reflected signal and a computing device including at least one processor and associated memory. The memory stores instructions that, upon execution by the at least one processor, cause the at least one processor to monitor the processed reflected signal, generate a graphical depiction of the processed reflected signal for a predetermined time, and identify a shift in frequency. The instructions also cause the processor to compare the shift in frequency to a set of known gestures, select a gesture of the set of known gestures that indicates the shift in frequency, and display, using a display module, the selected gesture.

In further aspects, the receiver is an interferometric receiver. In further aspects, the receiving antenna device includes a first receiving antenna and a second receiving antenna separated by a distance. In further aspects, the instructions include identifying, in the graphical depiction, a first peak at a first time and a second peak and a second time. The shift in frequency is a frequency difference between the first peak and the second peak.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a diagrammatic view of an interferometric receiver measuring angular velocity.

FIG. 1B is a functional block diagram of an exemplary embodiment of an interferometric radar for gesture recognition.

FIG. 2 is a diagrammatic view of an exemplary embodiment of a measured hand gesture described by ordered sequence of positions 1-3.

FIG. 3 is a functional block diagram of an exemplary embodiment of a gesture recognition radar system implementing an interferometer mode measurement method.

FIGS. 4A-4E are graphical depictions of a broadside response of the Doppler mode for five different gestures.

FIGS. 4F-4J are graphical depictions of an off-broadside (30° angle) response of the Doppler mode for five different gestures, showing a significant degradation in the signature compared to the broadside case of FIGS. 4A-4E.

FIGS. 5A-5E are graphical depictions of a broadside response of the interferometer mode for five different gestures where only in-phase data was measured.

FIGS. 5F-5J are graphical depictions of an off-broadside (30° angle) response of the interferometer mode for five different gestures, showing good signature persistence with angle when compared to the broadside case of FIGS. 5A-5E.

### DETAILED DESCRIPTION

Hand gesture recognition is important for improving human computer interactions (HCI) as well as to provide additional access to alternate forms of communication. More specifically, recognizing hand gestures using radar allows for human operation of devices without the need for a controller or buttons. Further, allowing a user to operate a device using known hand gestures prevents the need for using additional visual attention, such as when driving a vehicle. For example, a simple hand gesture while driving may generate a control signal to the vehicle's audio system, directing an adjustment of the audio volume. When implementing such gesture recognition techniques, recognition of hand gestures independent of a radar's direction is important to the robustness of the application as well as to improve user experience.

In further applications, such gesture recognition systems and methods can also identify directions of hand gestures and with sufficient sensitivity, identify small movements such as identifying American Sign Language and identifying hand gestures that correspond to different ASL words. Electromagnetic sensors have proven to provide a unique and useful approach to gesture recognition, in particular, Doppler radar sensors where the Doppler frequency shift of the response is measured over time. For non-rigid objects, such as the human body and the human hand, Doppler radar provides a unique capability to measure the velocities of the separate moving parts of the body. Each separate velocity generates a different Doppler frequency shift, yielding a dynamic multi-frequency response called micro-Doppler. Commonly processed in the time-frequency domain, micro-Doppler signatures can be used for classification of separate dynamic movements, and since the time-frequency response has lower dimensionality than two-dimensional video, can be processed with less computational burden than optical or IR imagers.

Various works have studied the use of radar for gesture recognition. One of the primary challenges involved with Doppler-based gesture recognition is the lack of a time-frequency response that remains persistent when the hand is not located directly broadside to the radar. Essentially, as the location of the hand creating the gesture moves to angles off-broadside, the radial motion of the hand and fingers relative to the radar degrades, and thus the micro-Doppler time-frequency response degrades. It has been shown that degradation of micro-Doppler signatures due to a lack of radial motion significantly degrades the performance of classifiers and recently it has been shown that gesture recognition suffers considerably when the hand is not located close to broadside.

To more closely monitor gesture recognition, a spatially-persistent radar hand gesture recognition system may be implemented based on direct measurements of the angular velocity of hand motions to improve HCI. Traditional radar-based gesture recognition utilizes Doppler-based measurements; however, the radial velocity and, thus, the Doppler time-frequency responses change significantly when the hand is not directly broadside to the radar, leading to degraded classification of gestures. Using a newly developed interferometric method of directly measuring angular velocity, the time-frequency signatures of hand gestures remain persistent when moving away from broadside, indicating that the interferometric technique can be used for more robust and reliable wireless HCI. Experimental measurements using a 16.9 GHz continuous-wave interferometric radar demonstrate that, for the Doppler mode, the maximum response bandwidth degrades by 71% when the gesture moves to 30° off-broadside, leaving a negligible time-frequency response. However, experimental results further show that the interferometric signature generated from the same data degrades in maximum bandwidth by only 16%, when the gesture moves to 30° off-broadside, with the response remaining largely identical.

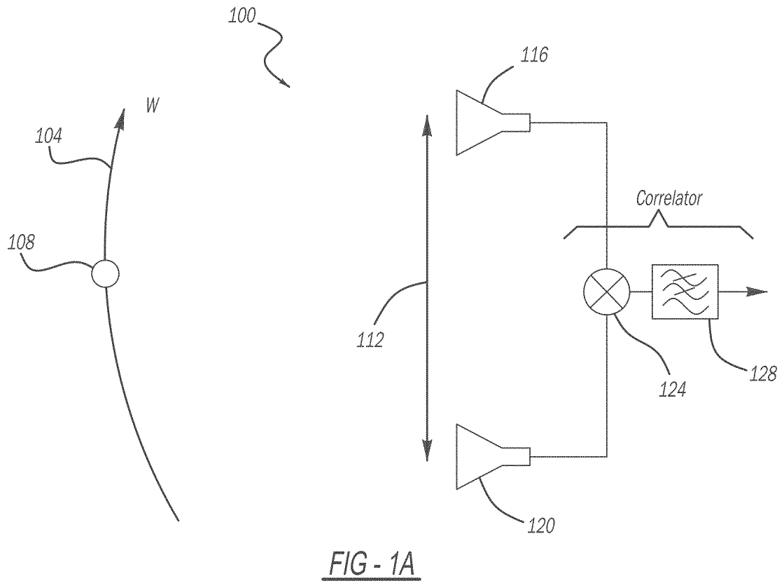

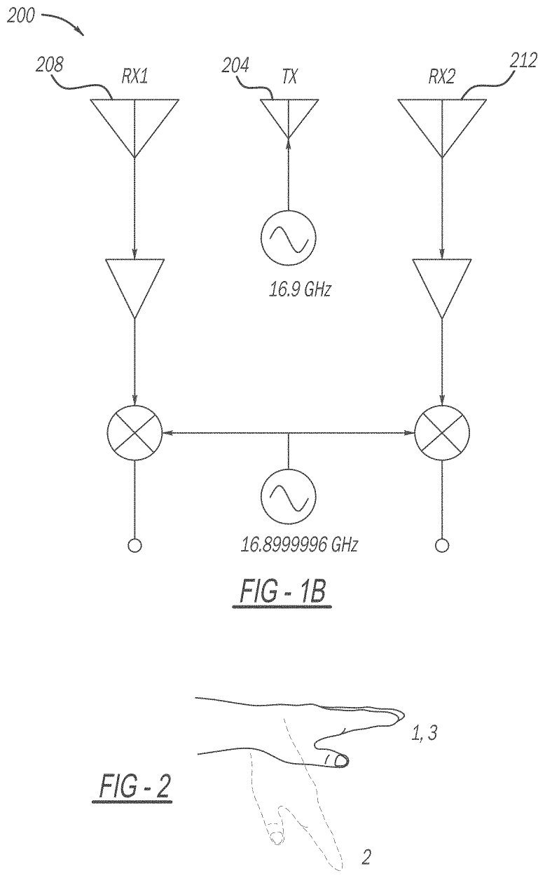

Referring now to FIG. 1A, a diagrammatic view of an interferometric receiver 100 measuring angular velocity is shown. As described above, the radial motion of a hand and fingers relative to a radar degrades, and thus the micro-Doppler time-frequency response degrades. To overcome this degradation, angular velocity is measured as well as the radial velocity, thereby enabling estimation of the motion, regardless of whether the trajectory is radial, relative to the radar or otherwise. A trajectory 104 of the motion of an object 108 is shown across from the interferometric receiver 100.

An interferometric radar technique using a distributed antenna aperture 112, shown by D, directly measures the angular velocity of the moving object 108 and shows that, in combination with a typical Doppler measurement, the trajectory of the moving object 108 can be estimated regardless of the trajectory 104 relative to the interferometric radar. In combination with the traditional radar measurements of range, radial velocity, and angle, the angular velocity measurement technique represents a fourth basic radar measurement and the theoretical accuracy of the four measurements take the same basic mathematical form.

The interferometric receiver 100 can collect interferometric angular velocity measurements for gesture recognition that remains persistent in angle. Because the interferometric technique measures angular velocity relative to the direction of an antenna baseline, any gestures generated at angular offsets orthogonal to that antenna baseline will theoretically remain the same. In principle, therefore, using a two-axis, three-element interferometer (e.g., two receivers and a transmitter) will generate persistent responses regardless of the offset of the object 108 in both angular dimensions. When comparing measurements of hand gesture motions at broadside and at 30° off broadside from a 16.9 GHz continuous-wave interferometric radar, the traditional time-frequency Doppler response and the time-frequency interferometric response shows that the response remains nearly identical for the interferometric angular velocity mode, while the response from the Doppler mode degrades to a negligible time-frequency response when off broadside. These measurements show that the interferometric radar signature remains largely the same when the hand moves from broadside to off-broadside, while the Doppler mode degrades significantly.

### Interferometric Measurement of Angular Velocity

The angular velocity measurement technique utilizes the unique radiation pattern generated by a distributed two-element antenna array. As seen in FIG. 1A, the interferometric receiver 100 is composed of a first antenna 116 and a second antenna 120, which may be two nominally identical antennas that are separated by a large number of wavelengths, while the transmitter (not shown) is a wide-beam antenna emitting a continuous-wave signal. The signal reflected off the object 108 and scattered back to the two antennas 116 and 120 generates received signals of the form:

$$\begin{matrix}{s}_{1} ( t ) = {A}_{1} cos ( 2 π ft ) \\ {s}_{2} ( t ) = {A}_{2} cos [ 2 π f ( t - τ ) ] , & ( 1 ) \\ τ = \frac{D}{c} sin ( θ ) , & ( 2 )\end{matrix}$$

is the difference in time delay of the reception of a given planar phase front at each antenna 116 and 120. By cross-correlating the two received signals, the output of the interferometric receiver can be shown to be:

$$r ( t ) = B cos [ 2 π f \frac{D}{c} sin ( ω t ) ] \qquad ( 3 )$$

where the angle θ (rad) has been substituted by the angular velocity ω (rad/s) using:

θ=ωt (4)

Near broadside angles, which can be enforced by using antennas with directional beams, the argument of the sin function becomes small (small θ), and the response is then:

$$r ( t ) \approx B cos ( 2 π \frac{D}{λ} ω t ) , \qquad ( 5 )$$

where λ=c/ƒ is the wavelength of the transmitted signal.

The instantaneous frequency of Equation 5 is thus:

$${f}_{s} = \frac{ω D}{λ} , \qquad ( 6 )$$

Therefore, the frequency of the interferometer response is directly proportional to the angular velocity ω of the object. Furthermore, Equation 6 is mathematically nearly identical to the Doppler frequency shift ƒ_{d}=2v/λ, where v is the radial velocity. As such, the responses from the interferometric mode and the Doppler mode are quite similar for point objects, such as the object 108. When multiple objects are present, and each are scattering signals simultaneously, the response becomes more complicated due to the nonlinear processing involved with the correlator, which includes a mixer 124 and a low pass filter 128. When nonlinearities due to this process are mitigated, the time-frequency responses of a moving person generated by the Doppler and interferometric modes manifest similarly, suggesting that traditional Doppler processing may be applied to interferometric processing.

In the above derivation, the signal output produces a non-complex signal response, which generates the same frequency shift whether the object 108 is moving in a positive or negative angular trajectory. If a complex correlator is used and the in-phase and quadrature signals captured, the complex interferometer response generates positive and negative frequencies, indicating positive or negative angular trajectories. This is similar to how the Doppler mode produces positive and negative frequencies for approaching and receding objects, respectively.

The important concept to note for hand gesture recognition is that the interferometric radar measures the angular velocity relative to the two-element distributed array baseline. That is, any offset in the position orthogonal to the baseline of the object 108 in FIG. 1A (i.e., the direction into or out of the page) has theoretically no effect on the angular velocity measurement. The response will change only in amplitude due to the antenna patterns of the receiver antennas 116 and 120. In other words, the response may be attenuated, but the frequency shift will not change. Thus, the ability to measure angular velocity with this approach is persistent relative to offset positions orthogonal to the antenna baseline. For hand gesture recognition, this means that the user does not need to precisely position the hand broadside to the radar to guarantee high classification rates.

### Interferometric Gesture Recognition Radar

A 16.9 GHz interferometric radar or gesture recognition system 200 is shown in FIG. 1B. The gesture recognition system 200 includes a transmitter 204 consisting of a continuous-wave 16.9 GHz signal emitted through a 10 dBi standard gain horn antenna located between a first receiver 208 and a second receiver 212. The receivers 208 and 212 may each have a 20 dBi standard gain horn antenna. The receiving antennas of the receivers 208 and 212 were chosen with narrower beamwidths than the transmitting antenna of the transmitter 204 to ensure that the overlap of the receiving signals were entirely encompassed by the transmitted signal. Amplifiers, for example, may follow each the receiving antennas with a gain of 28 dB and noise figure of 5 dB. After amplification, the received signals may be down-converted to an intermediate frequency (IF) of 400 Hz to ensure that both positive and negative Doppler shifts are captured. In example embodiments, the two received signals may be captured individually and also directly multiplied using a built-in math function of an oscilloscope. The received signals may be processed off-line using a short-time Fourier transform (STFT) with a window length and FFT size of 256. The Doppler time-frequency response, shown and described below, is generated from an individual antenna element of the two receiving antennas while the interferometric response is from the multiplied signal.

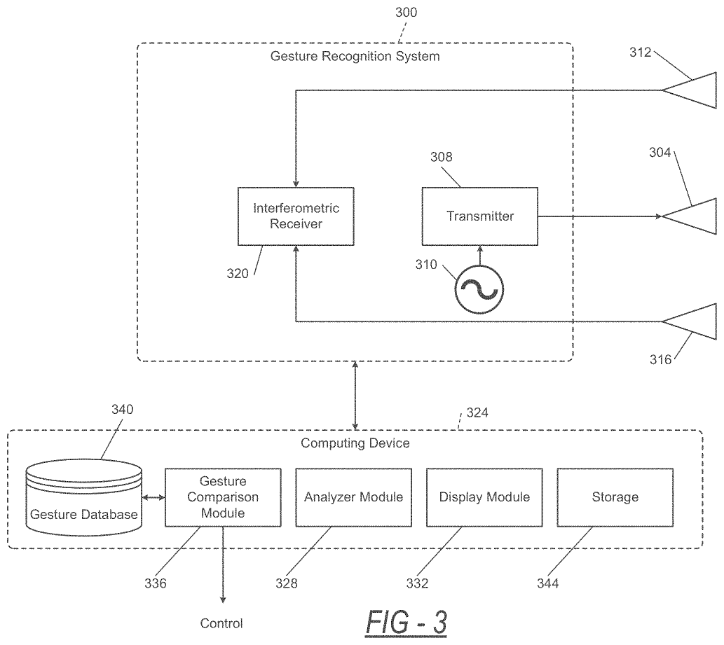

In various implementations, the gesture recognition system 200 can recognize the angular persistence of a hand gesture. For example, the movement or gesture of the hand is shown in FIG. 2, a swiping downward then upward motion starting in position 1, swiping down to position 2, and upward to the original position 3. This example motion contains a large radial displacement, which generates a large Doppler frequency shift, and is therefore a gesture that should be less susceptible to degradation due to angular displacement. To monitor the gesture of FIG. 2, the antennas of the transmitter 204 and receivers 208 and 212 of the gesture recognition system 200 are pointed upwards for measuring, and the gesturing hand is approximately 20 cm above the antennas of the transmitter 204 and the receivers 208 and 212 of the gesture recognition system 200. Similarly, a gesture recognition system of FIG. 3 can also measure the described hand gesture shown in FIG. 2.

Referring now to FIG. 3, a functional block diagram of an example gesture recognition system 300 is shown. In various implementations, the gesture recognition system 300 may be implemented in a device, such as a vehicle, a television, etc., for recognizing hand gestures and generating a corresponding command based on those hand gestures. As mentioned above, the gesture recognition system 300 is similar to the gesture recognition system 200 of FIG. 1B. The gesture recognition system 300 includes a transmitting antenna 304 and a transmitter 308 configured to transmit a signal to be reflected off an object, for example, a hand. The transmitted signal may be generated by a first oscilloscope 310. A first receiving antenna 312 and a second receiving antenna 316 receive the signal reflected off the object and an interferometric receiver 320 mixes the signals. As described above, implementing the gesture recognition system 300 using two receiving antennas 312 and 316 separated by a distance allows the gesture recognition system 300 to identify and measure angular velocity of the object, regardless of any offset in both angular directions. In various implementations, the interferometric receiver 320 may also include a low pass filter.

A computing device 324 receives the signals from the gesture recognition system 300 for display and analysis. In various implementations, the computing device 324 may include an analyzer module 328 that receives the signals reflected off the object and performs processing, as described above, using a STFT with a window length and FFT size of 256 in real time or after the collection of the reflected signals for a predetermined period. The analyzer module 328 may generate a graphical depiction of the gesture captured from the reflected signals. In various implementations, a display module 332 may receive the analyzed gestures and display the resulting graphical depictions.

In various implementations, the display module 332 may instruct the display of the above-described graphical depictions onto a display screen of the computing device. For example, the described gesture recognition system 300 may be implemented to monitor objects and identify which gestures the monitored objects are performing in order to generate a corresponding control signal. Additionally, the described gesture recognition system 300 may be implemented to simply monitor objects and display graphical depictions of frequency shifts based on motion of the objects.

Additionally, the computing device 324 may include a gesture comparison module 336 that compares the analyzed gesture generated by the analyzer module 328 with known gestures included in a gesture database 340. The gesture comparison module 336 may identify whether the analyzed gesture is a known gesture and output a control signal or instruction to a device. The control instruction may control the computing device 324 or another device that the gesture is intended to control. The computing device 324 may also include a separate storage 344 for monitoring a history of analyzed gestures to implement machine learning algorithms and/or for post-processing purposes.

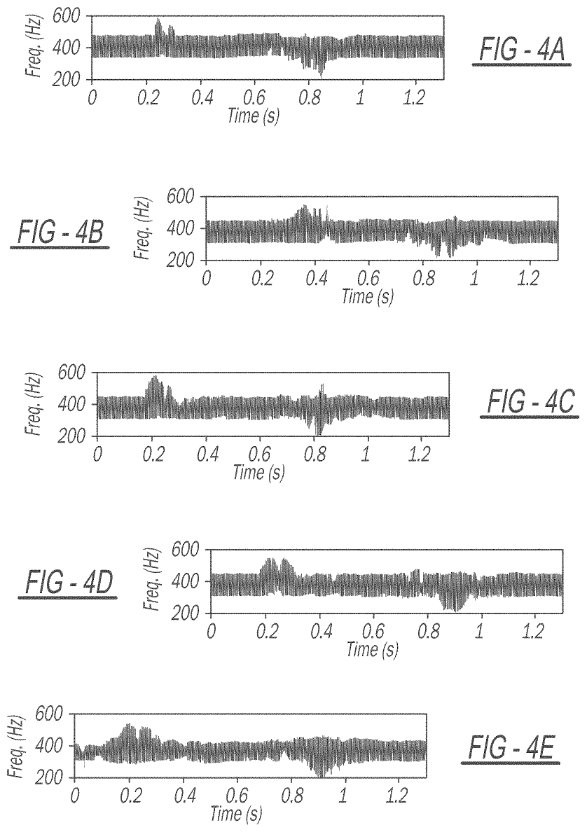

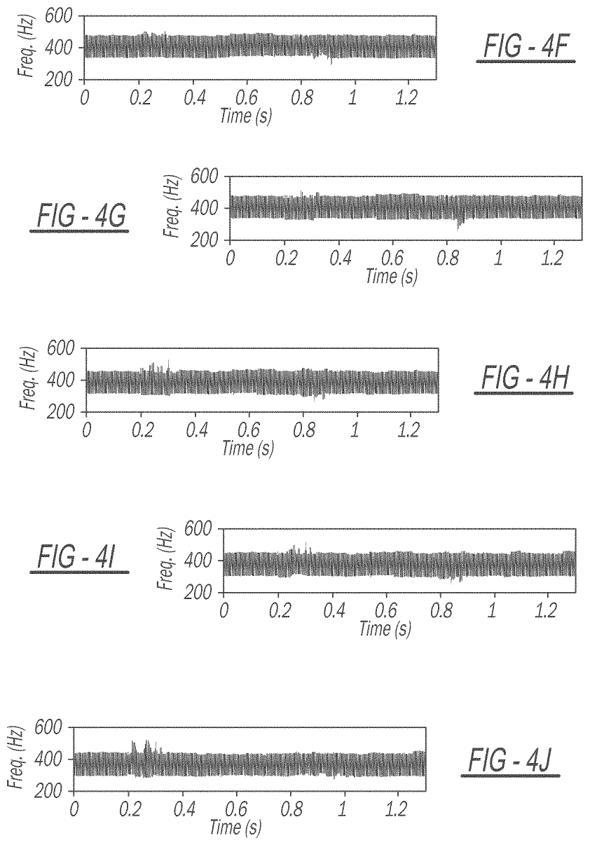

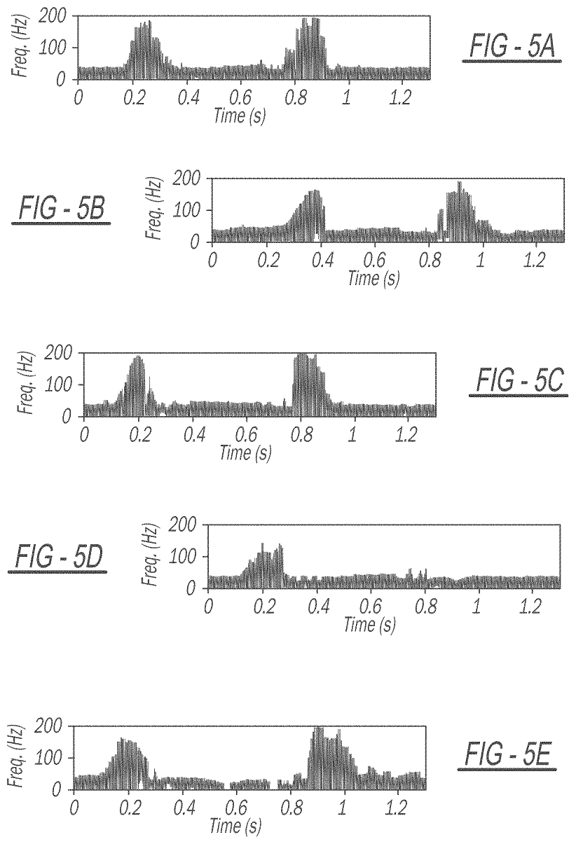

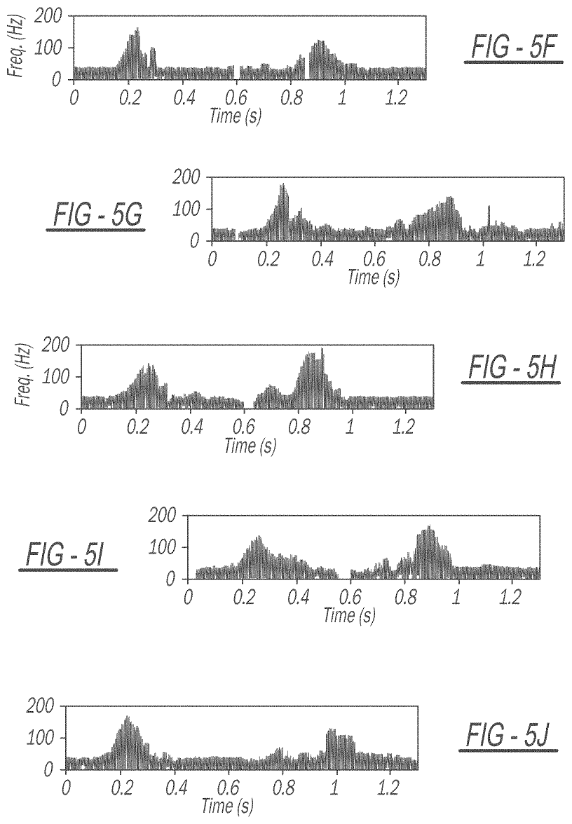

Referring now to FIGS. 4A-5J, a set of five measurements in the previously described configuration of the hand gesture of FIG. 2 at broadside θ=0° and five measurements at a displacement of θ=30° off broadside are shown. Specifically, FIGS. 4A-4E depict the time-frequency responses of the Doppler response for the broadside measurement, and FIGS. 4F-4J depicts the time-frequency responses of the Doppler response for the off-broadside measurement. As noted above, the Doppler responses shown are centered at 400 Hz due to the difference in the transmitting and downconverting oscillators (as shown in the configuration of FIG. 1B), ensuring that positive and negative Doppler shifts are detected. The broadside measurements in FIGS. 4A-4E show a clear response corresponding to the gesture. A first peak in each response graph of FIGS. 4A-4E has a positive frequency corresponding to the downward motion of the hand from position 1 to position 2 (shown in FIG. 2), which moving towards the gesture recognition system produces a positive frequency shift. A second peak in each response graph of FIGS. 4A-4E shows the upward motion from position 2 to position 3, which, moving away from the gesture recognition system produces a negative frequency shift. The Doppler time-frequency response off-broadside clearly degrades, as the response in FIGS. 4F-4J is effectively negligible compared to the broadside response. Additional signal processing may help to recover the Doppler signal in the off-broadside case, but nonetheless the measurements clearly indicate that the signal changes significantly due to angular displacement of the hand.

FIGS. 5A-5E depict the time-frequency responses for the interferometric signal for the broadside measurement, and FIGS. 5F-5J depict the time-frequency responses for the interferometric signal for the off-broadside measurement. Once again, the peaks shown correspond to the hand motion, though, because only the real portion of the signal was captured (that is, only in-phase data was measured), both appear as a positive frequency shift. Clearly, the interferometric responses at broadside in FIGS. 5A-5E and off-broadside in FIGS. 5F-5J produce a very similar response. The slight degradation of the peaks may be from the reduced amplitude due to the hand being placed in a lower gain region of the receiver antenna patterns, as mentioned previously. Despite this, the signatures at broadside, FIGS. 5A-5E, and off-broadside, FIGS. 5F-5J, are quite similar for the interferometric response, while the Doppler response changes from a discernible signal at broadside, FIGS. 4A-4E, to effectively negligible at off-broadside, FIGS. 4F-4J.

In various implementations, the graphs of FIGS. 4A-5J may be analyzed to determine maximum frequency shifts. As described with respect to FIG. 3, the analyzer module may perform such analyses to compare frequency shifts. For example, the maximum frequency shift detected for each response may be calculated, and then the degradation in maximum frequency shift from broadside to off-broadside may be determined. The maximum frequency shift for the interferometric mode of FIGS. 5A-5J may be calculated using a threshold of 15 dB from the peak response, and the Doppler mode of FIGS. 4A-4J may be calculated using a threshold of 12.5 dB from the peak response. From this, the maximum frequency of the Doppler mode degraded by 71% in when moving from broadside to off-broadside, while the maximum frequency of interferometric mode degraded by only 16%.

Therefore, the time-frequency signatures generated by gestures remain more persistent with angle in the interferometric mode than in the Doppler mode. Furthermore, the maximum frequency of the interferometric mode degrades by only a small amount, while the Doppler signal reduces to a nearly negligible response. The interferometric technique implemented by the described gesture recognition systems result in more reliable and more robust HCI gesture recognition.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

While various embodiments have been disclosed, it should be appreciated that additional variations of the radar-based gesture recognition system are also envisioned. For example, additional or different hardware components may be used although certain of the present advantages may not be fully realized. It is also noteworthy that any of the preceding features may be interchanged and intermixed with any of the others. Accordingly, any and/or all of the dependent claims may depend from all of their preceding claims and may be combined together in any combination. Variations are not to be regarded as a departure from the present disclosure, and all such modifications are entitled to be included within the scope and spirit of the present invention.

What is claimed is:

1. A gesture recognition system comprising:
a transmitting antenna configured to transmit a signal generated by a transmitter onto an object;
a receiving antenna device configured to receive a reflected signal, wherein the reflected signal is a reflection of the transmitted signal reflected off the object;
a receiver configured to process the reflected signal;
a gestures database configured to store a set of known gestures represented by a corresponding frequency; and
an analyzing device configured to:
compute a shift in frequency over a predetermined period based on the processed reflected signal;
obtain the set of known gestures stored in the gestures database;
select a first gesture included in the set of known gestures based on a corresponding first frequency matching the computed shift in frequency; and
output the selected first gesture to a display.

2. The system of claim 1 wherein computing the shift in frequency over the predetermined period based on the processed reflected signal includes:
computing a first frequency based on a first velocity of a first reflected signal, and
computing a second frequency based on a second velocity of a second reflected signal, wherein the shift in frequency is a difference between the first frequency and the second frequency.

3. The system of claim 1 wherein outputting the selected first gesture to the display includes:
outputting a selected graphic of the selected first gesture.

4. The system of claim 1 wherein the receiver configured to process the signal is further configured to measure an angular velocity of the object based on the reflected signal.

5. The system of claim 1 wherein the receiver is an interferometric receiver.

6. The system of claim 1 wherein the receiving antenna device includes a first receiving antenna and a second receiving antenna spaced a preset distance apart.

7. The system of claim 6 wherein:
the first receiving antenna receives a first reflected signal,
the second receiving antenna receives a second reflected signal, and
computing the shift in frequency over the predetermined period based on the processed reflected signal includes calculating an angular velocity of the object based on the first reflected signal and the second reflected signal.

8. The system of claim 1 wherein:
the receiver includes a mixer and a low pass filter.

9. The system of claim 1 wherein the display is configured to display on a screen a graphical depiction of the shift in frequency.

10. A gesture recognition method comprising:
transmitting a signal generated by a transmitter onto an object;
receiving, by a receiver, a reflected signal, wherein the reflected signal is a reflection of the transmitted signal reflected off the object;
monitoring the reflected signal for a predetermined time;
calculating a first velocity at a first time of the reflected signal and a second velocity at a second time, wherein a difference between the first time and the second time is the predetermined time;
determining a frequency shift over the predetermined time based on the first velocity and the second velocity;
obtaining a set of known gestures, wherein the set of known gestures is stored in a gestures database and each gesture of the set of known gestures corresponds to a predetermined frequency;
comparing the frequency shift to the set of known gestures;
selecting a first gesture of the set of known gestures based on a first predetermined frequency of the first gesture matching the frequency shift; and
outputting the first gesture to a display screen.

11. The method of claim 10 further comprising:
computing a first frequency based on the first velocity at the first time, and
computing a second frequency based on the second velocity at the second time, wherein the frequency shift is the difference between the first frequency and the second frequency.

12. The method of claim 10 further comprising:
outputting a graphic of the selected first gesture.

13. The method of claim 10 wherein the receiver measures an angular velocity of the object based on the reflected signal.

14. The method of claim 10 wherein the receiver is an interferometric receiver.

15. The method of claim 10 wherein the receiver receives the reflected signal from a first receiving antenna and a second receiving antenna spaced apart.

16. The method of claim 10 wherein the first velocity and the second velocity are angular velocities.

17. A gesture recognition system comprising:
a transmitting antenna configured to transmit a signal generated by a transmitter onto an object;
a receiving antenna device configured to receive a reflected signal, wherein the reflected signal is a reflection of the transmitted signal reflected off the object;
a receiver configured to process the reflected signal; and
a computing device including at least one processor and associated memory, wherein the memory stores instructions that, upon execution by the at least one processor, cause the at least one processor to:
monitor the processed reflected signal;
generate a graphical depiction of the processed reflected signal for a predetermined time;
identify a shift in frequency;
compare the shift in frequency to a set of known gestures;
select a gesture of the set of known gestures that indicates the shift in frequency; and
display, using a display module, the selected gesture.

18. The system of claim 17 wherein the receiver is an interferometric receiver.

19. The system of claim 17 wherein the receiving antenna device includes:
a first receiving antenna and a second receiving antenna separated by a distance.

20. The system of claim 17 wherein the instructions include:
identifying, in the graphical depiction, a first peak at a first time and a second peak and a second time, wherein the shift in frequency is a frequency difference between the first peak and the second peak.
